(19) United States
(12) Patent Application Publication
(10) Pub. No.: US 2025/0263109 A1
(43) Pub. Date: Aug. 21, 2025

(54) VEHICLE STEERING APPARATUS AND VEHICLE INCLUDING SAME

(71) Applicant: HL MANDO CORPORATION, Gyeonggi-do (KR)

(72) Inventor: Jae Young NOH, Gyeonggi-do (KR)

(21) Appl. No.: 19/019,404

(22) Filed: Jan. 13, 2025

(30) Foreign Application Priority Data
Feb. 20, 2024 (KR) 10-2024-0024630

(51) Int. Cl. B62D 5/04

(52) U.S. Cl. CPC B62D 5/0421; B62D 5/0442; B62D 5/046

(57) ABSTRACT

A vehicle steering apparatus comprises an input shaft, an output shaft, and a torsion restoring member. The input shaft includes an insertion portion on the bottom end, the insertion portion having a space axially defined therein, and is coupled at the top end to a steering shaft to transmit a steering rotational force. The output shaft is coupled at the top end to the insertion portion and at the bottom end to a rack bar to transmit the steering rotational force to the rack bar. The torsion restoring member is coupled between the inner surface of the insertion portion and the top end of the output shaft to elastically deform upon rotation of the input shaft.

### CROSS REFERENCE TO RELATED APPLICATION

This application claims priority from Korean Patent Application No. 10-2024-0024630, filed on Feb. 20, 2024, which is hereby incorporated by reference for all purposes as if fully set forth herein.

### BACKGROUND

### Field

Embodiments relate to a vehicle steering apparatus and a vehicle including the same.

### Description of Related Art

In a vehicle steering apparatus and a vehicle, a steering shaft includes a lower steering shaft and an upper steering shaft coupled thereto. The upper steering shaft is connected to a steering wheel and configured such that an input shaft of the lower steering is connected to an output shaft coupled to a rack bar to transmit a steering force of the steering wheel.

One end of the lower steering shaft is coupled to the input shaft, and is coupled to the input shaft and a torsion bar by a pin.

The torsion bar is coupled to the input shaft and the output shaft within the input shaft and the output shaft, and acts as a type of torsion spring that rotates and twists together with the input shaft as the steering shaft rotates. The relative amount of torsion between the input and output shafts is measured by a torque sensor and sent to an electronic controller, which in turn generates a control signal to control generation of an auxiliary steering force.

However, conventional torsion bars with such a structure and acting as torsion springs on steering shafts have suffered from difficulties in torsion bar manufacturing and machining processes and assembly processes such as pin-fixing to the input and output shafts. The need to manufacture torsion bars of different lengths depending on the vehicle type may reduce productivity and increase costs, and there are difficulties in tuning the stiffness of torsion bars.

Therefore, there is an increasing need for research on a vehicle steering apparatus that may minimize the cost increase and improve the assemblability by replacing and commonizing existing torsion bars.

### BRIEF SUMMARY

Various aspects provide a vehicle steering apparatus that may minimize the cost increase and improve the assemblability by replacing and commonizing existing torsion bars.

According to embodiments, provided is a vehicle steering apparatus including an input shaft coupled to a steering shaft and including an insertion portion on a end of the input shaft, the insertion portion of the input shaft having an inner space formed in the insertion portion in an axial direction of the input shaft, an output shaft, wherein one end of the output shaft is coupled to the insertion portion of the input shaft and another end of the output shaft is coupled to a rack bar, and a torsion restoring member coupled between the inner surface of the insertion portion of the input shaft and the one end of the output shaft, and configured to be elastically deformable in response to rotation of the input shaft.

According to embodiments, also provided is a vehicle steering apparatus including an input shaft coupled to a steering shaft and including an insertion portion on an end of the input shaft, the insertion portion of the input shaft having an inner space formed, in the insertion portion in an axial direction of the input shaft, an output shaft, wherein one end of the output shaft is coupled to the insertion portion of the input shaft and another end of the output shaft is coupled to a rack bar, a torsion restoring member coupled between the insertion portion and the one end of the output shaft, coupled to be elastically deformable in response to rotation of the input shaft, and a rotational support member coupled to the one end of the output shaft and coupled between an inner surface of the insertion portion of the input shaft and the torsion restoring member to support rotation of the output shaft.

According to embodiments, also provided is a vehicle including a steering shaft connected to a steering wheel, an input shaft coupled to the steering shaft and including an insertion portion on an end of the input shaft, the insertion portion of the input shaft having an inner space formed in the insertion portion in an axial direction of the input shaft, an output shaft, wherein one end of the output shaft is coupled to the insertion portion of the input shaft and at another end of the output shaft is coupled to a rack bar, a rack driver coupled to the rack bar and configured to control movement of the rack bar, a torsion restoring member coupled between an inner surface of the insertion portion of the output shaft coupled and the one end of the output shaft, coupled to the insertion portion of the input shaft, and configured to be elastically deformable in response to rotation of the input shaft, a torque sensor configured to sense torque of the input shaft, and an electronic controller configured to output a control signal to the rack driver according to the torque of the input shaft.

According to embodiments, both minimizing the cost increase and improving the assemblability may be achieved by replacing and commonizing existing torsion bars.

### DESCRIPTION OF DRAWINGS

The above and other objects, features, and advantages of the present disclosure will be more clearly understood from the following detailed description, taken in conjunction with the accompanying drawings, in which:

FIG. 1 is a schematic view illustrating a vehicle according to embodiments;

FIG. 2 is a perspective view illustrating portions of a vehicle steering apparatus according to embodiments;

FIGS. 3 and 4 are exploded perspective views illustrating portions of the vehicle steering apparatus according to embodiments;

FIG. 5 a perspective view illustrating portions of the vehicle steering apparatus according to embodiments;

FIGS. 6 and 7 are exploded perspective views illustrating portions of the vehicle steering apparatus according to embodiments;

FIGS. 8 and 9 are perspective views illustrating portions of the vehicle steering apparatus according to embodiments; and

FIGS. 10 to 13 are cross-sectional views illustrating portions of the vehicle steering apparatus according to embodiments.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting”, “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term or “directly” “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

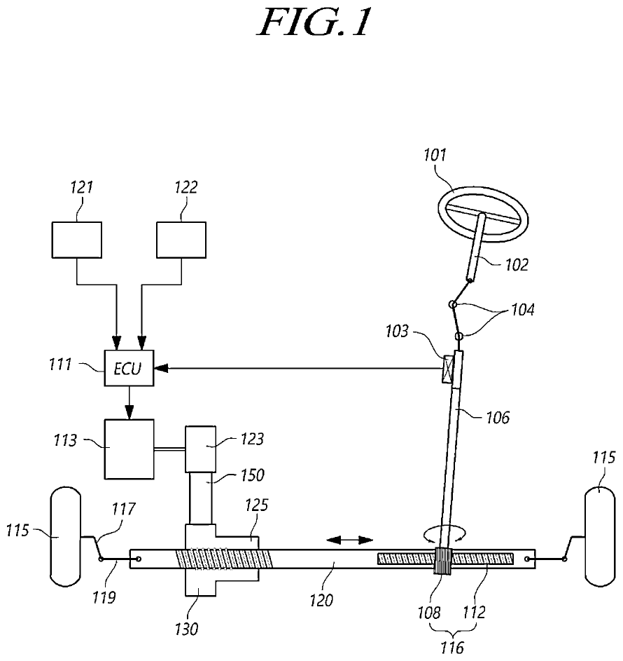

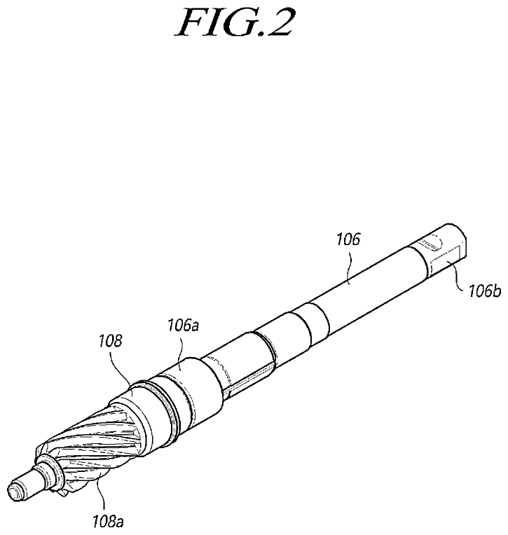

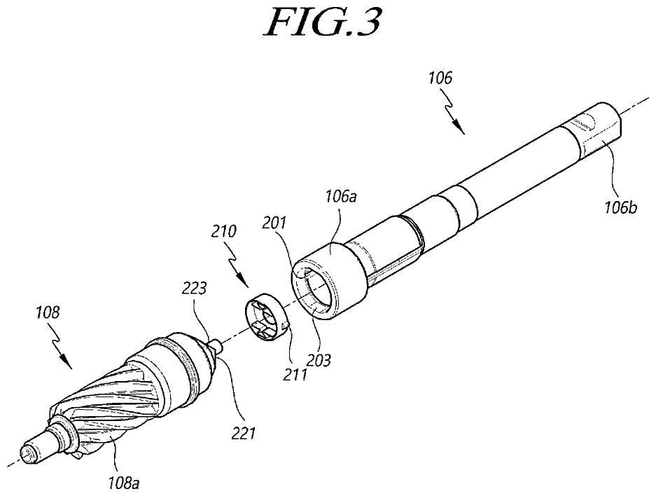

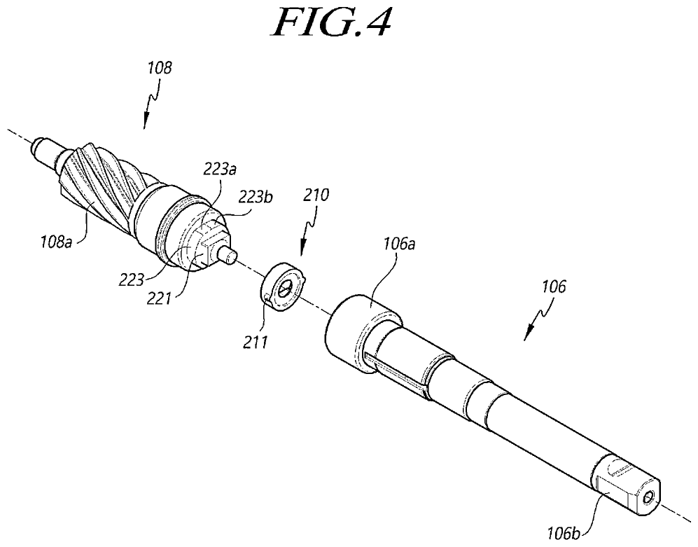

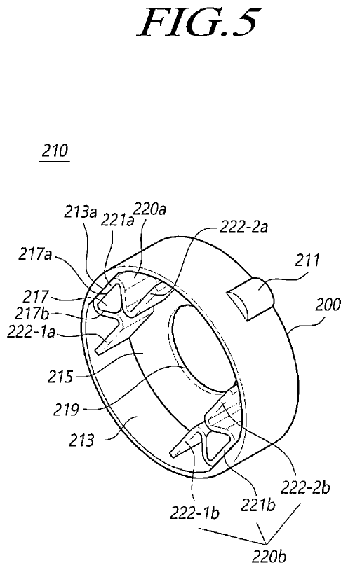

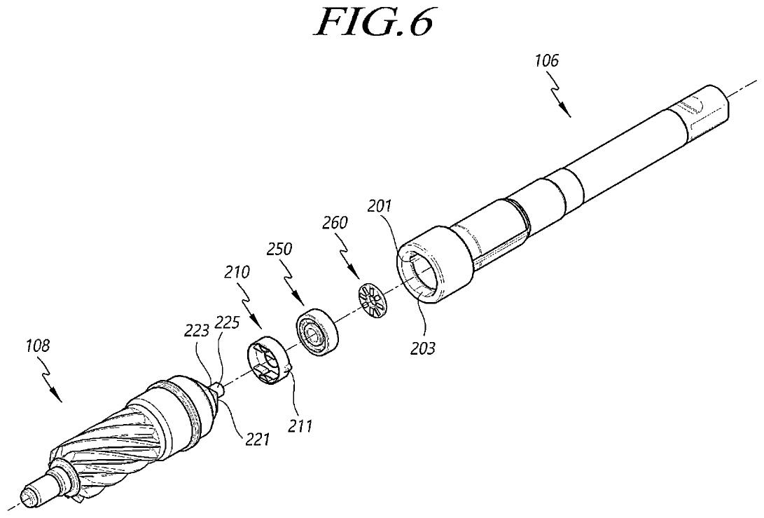

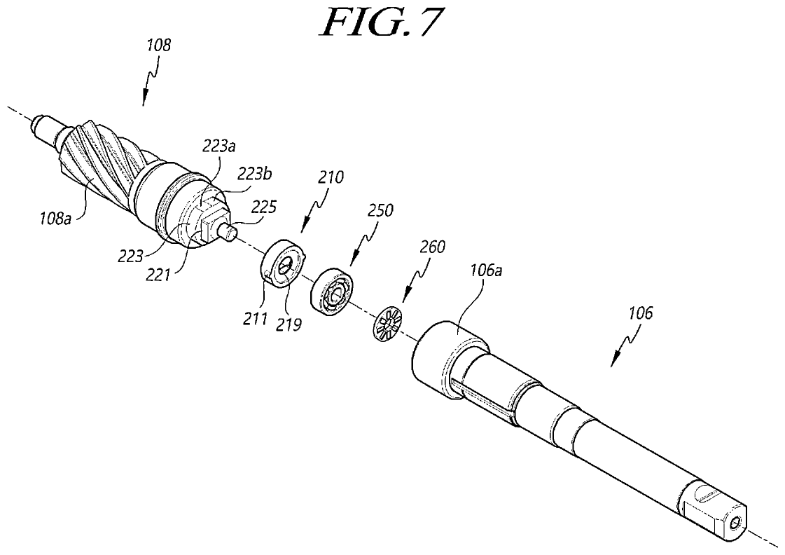

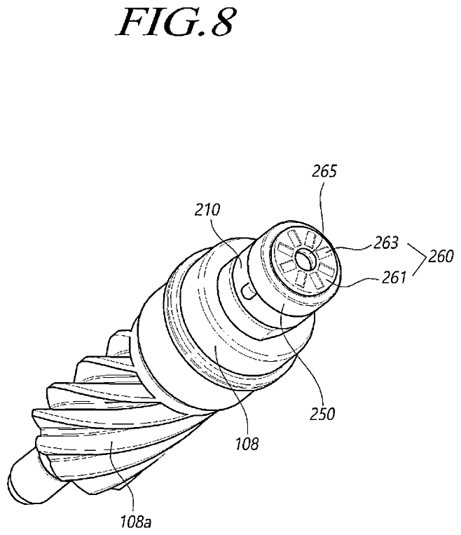

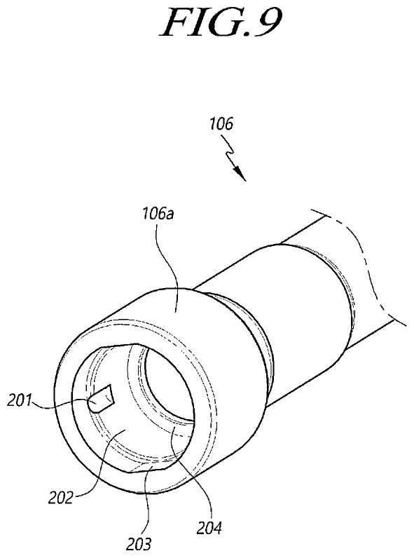

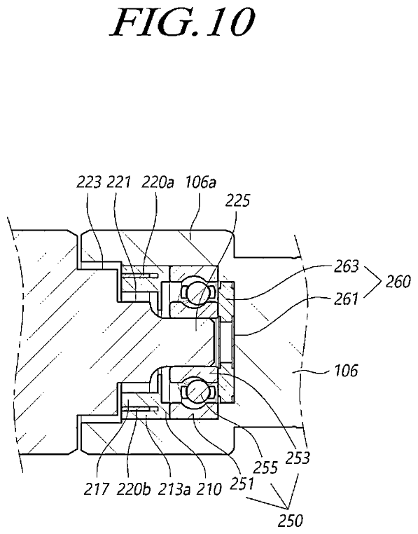

FIG. 1 is a schematic view illustrating a vehicle according to embodiments, FIG. 2 is a perspective view illustrating portions of a vehicle steering apparatus according to embodiments, FIGS. 3 and 4 are exploded perspective views illustrating portions of the vehicle steering apparatus according to embodiments, FIG. 5 a perspective view illustrating portions of the vehicle steering apparatus according to embodiments, FIGS. 6 and 7 are exploded perspective views illustrating portions of the vehicle steering apparatus according to embodiments, FIGS. 8 and 9 are perspective views illustrating portions of the vehicle steering apparatus according to embodiments, and FIGS. 10 to 13 are cross-sectional views illustrating portions of the vehicle steering apparatus according to embodiments.

First, embodiments will be described with reference to FIGS. 1 to 5.

According to the present embodiments, provided may be a vehicle steering apparatus including: an input shaft 106 coupled to a steering shaft 102 and including an insertion portion 106a on an end of the input shaft 106, the insertion portion 106a of the input shaft 106 having an inner space formed in the insertion portion 106a in an axial direction of the input shaft 106, an output shaft 108, wherein one end of the output shaft 108 is coupled to the insertion portion 106a of the input shaft 106 and another end of the output shaft 108 is coupled to a rack bar 120, and a torsion restoring member 210 coupled between an inner surface of the insertion portion 106a of the input shaft 106 and the one end of the output shaft 108, coupled to the insertion portion 106a of the input shaft 106, and configured to be elastically deformable in response to rotation of the input shaft 106.

Referring to FIG. 1 the vehicle of the present embodiments is configured such that the steering shaft 102 connected to a steering wheel 101 is coupled to the input shaft 106 through a universal joint 104, and an electronic controller 111, such as an electronic control unit (ECU), sends a control signal to a motor 113 to steer two wheels 115 through tie rods 119 based on information received from a torque sensor 103 detecting torque on the input shaft in response to the driver operating the steering wheel 101, a steering angle sensor 121, a speed sensor 122, and the like.

In the present embodiments, the steering shaft 102 at the top is connected to the input shaft 106 at the bottom through the universal joint 104 and allows steering to be performed by a rack-and-pinion device 116 including a pinion 108 and a rack gear 112.

Here, the driving force of the motor 113 driven by the electronic controller 111 is transmitted from the motor 113 to a ball nut 125 through the belt 150, thereby causing the rack bar 120 coupled to the ball nut 125 by a ball to slide axially. The tie rods 119 are coupled to the opposite ends of the rack bar 120. The tie rods 119 are coupled to knuckle arms 117 connected to the wheels 115 to steer the wheels 115.

A motor pulley 123 connected to the shaft of the motor 113 and a nut pulley 130 connected to the ball nut 125 are arranged in parallel. A belt 150 is coupled to the motor pulley 123 and the nut pulley 130 to transmit the rotational force of the motor 113 to the rack bar 120 through the ball nut 125. The rack bar 120 may be moved from side to side by the motion of the ball nut 125 to generate a steering assist force.

An electrical signal generated by the torque sensor 103 is sent to the electronic controller 111, and the electronic controller 111 controls the motor 113 based on an electrical signal transmitted by the torque sensor 103 and electrical signals transmitted by the steering angle sensor 121, the speed sensor 122, and the like mounted on the vehicle.

Referring to FIG. 2, the bottom end of the input shaft 106 is provided with the insertion portion 106a having a space axially defined therein, and the top end of the input shaft 106 is provided with a coupling portion 106b that is coupled to the steering shaft 102 to transmit the steering rotational force as the steering shaft 102 rotates.

The top end of the output shaft 108 is coupled to the insertion portion 106a of the input shaft 106, and the output shaft 108 is provided with a pinion gear 108a on the bottom end and is coupled to the rack gear 112 of the rack bar 120 to transmit the steering rotational force of the input shaft 106 to the rack bar 120.

As shown in FIGS. 3 and 4, the torsion restoring member 210 is coupled between the inner surface of the insertion portion 106a and the top end of the output shaft 108 to elastically deform and generate an elastic restoring force upon rotation of the input shaft 106.

Referring to FIG. 5, the torsion restoring member 210 includes a fixed housing 200 fixed to the insertion portion 106a and elastic members 220a and 220b each having a first end and a second end supporting the output shaft 108, wherein a portion of the elastic member 220a between the first and second ends of the elastic member 220a is fixed to the fixed housing 200 of the torsion restoring member 210.

As shown in FIG. 4, the output shaft 108 is provided with an axially protruding support end 223 protruding from the one end of the output shaft 108 coupled to the insertion portion 106a of the input shaft 106, and the support end 223 is provided with stopper surfaces 223a and 223b formed as incised planes on the radially opposite sides of the support end 223.

In addition, the insertion portion 106a is provided with a support surface 203 on the inner circumferential surface of the end of the input shaft 106, the stopper surfaces 223a and 223b of the output shaft 108 being supported on the support surface 203 upon rotation of the input shaft 106.

The stopper surfaces 223a and 223b are configured such that the first stopper surface 223a and the second stopper surface 223b are connected at an angle. The first stopper surface 223a is supported and stopped on the support surface 203 upon clockwise rotation of the input shaft 106, and the second stopper surface 223b is supported and stopped on the support surface 203 upon counterclockwise rotation of the input shaft 106.

In addition, the output shaft 108 is provided with protruding ends 221 on the top end, the protruding ends 221 axially protruding from the support end 223 and supported on first and second ends of the elastic members 220a and 220b. Upon rotation of the input shaft 106, the protruding ends 221 are supported on the first and second ends of the elastic members 220a and 220b, thereby causing elastic deformation.

The protruding ends 221 are provided as a plane, in which the opposite sides in the radial direction about the central axis are parallel to each other.

In addition, the elastic members 220a and 220b are provided as a pair of elastic members symmetrically disposed on the opposite sides of the protruding ends 221 such that the elastic restoring force generated on the elastic members 220a and 220b by the protruding ends 221 upon rotation of the input shaft 106 is applied equally to the opposite sides of the protruding ends 221.

Referring to FIG. 5 again in conjunction with FIGS. 3 and 4, the fixed housing 200 includes a cylindrical portion 213 coupled to the inner circumferential surface of the insertion portion 106a, a vertical partition 215 extending from a first end of the cylindrical portion 213, and fixing protrusions 217 each protruding axially from the vertical partition 215, such that a portion between a first end and a second end of each of the elastic members 220a and 220b is coupled to one of the fixing protrusions 217.

The cylindrical portion 213 is provided with radially protruding support protrusions 211 protruding from the outer circumferential surface, and the insertion portion 106a is provided on the inner circumferential surface with seating recesses 201 into which the support protrusions 211 are inserted, so that the fixed housing 200 is fixed to the inner circumferential surface of the insertion portion 106a without idling.

The fixing protrusions 217 are spaced apart from the inner circumferential surface of the cylindrical portion 213, and the portions between the first and second ends of the elastic members 220a and 220b are disposed between the inner circumferential surface of the cylindrical portion 213 and the fixing protrusions 217.

One of the fixing protrusions 217 has a flat surface 217a that is provided as a plane at a position opposite the inner circumferential surface of the cylindrical portion 213. The cylindrical portion 213 is provided with a flat surface 213a on the inner circumferential surface, the flat surface 213a of the cylindrical portion 213 is parallel to the flat surface 217a of the fixing protrusions 217.

In addition, one of the fixing protrusions 217 includes inclined portions 217b extending radially from the ends of the flat surface 217a facing the inner circumferential surface of the cylindrical portion 213.

Each elastic member 220a or 220b includes shaft support members 222-1a and 222-2a or 222-1b and 222-2b each having first and second ends bilaterally disposed on the same plane to support the outer circumferential portions of the output shaft 108 and fixing protrusions 221a and 221b bent at the inner ends of the shaft support members 222-1a and 222-2a or 222-1b and 222-2b to wrap around and fix the inclined portions 217b and the flat surface 217a of the fixing protrusion 217.

Referring to FIGS. 6 to 13, the vehicle steering apparatus according to the present embodiments includes: an input shaft 106 coupled to a steering shaft 102 and including an insertion portion 106a on an end of the input shaft 106, the insertion portion 106a having an inner space formed in the insertion portion 106a in an axial direction, an output shaft 108, wherein one end of the output shaft 108 is coupled to the insertion portion 106a and another end of the output shaft is coupled to a rack bar 120, a torsion restoring member 210 coupled between an inner surface of the insertion portion 106a and the one end of the output shaft 108, and configured to be elastically deformable in response to rotation of the input shaft 106, and a first rotational support member 250 coupled to the one end of the output shaft 108 and coupled between the inner surface of the insertion portion 106a and the torsion restoring member 210 to support rotation of the output shaft 108.

Here, the torsion restoring member 210 includes a fixed housing 200 fixed to the insertion portion 106a and elastic members 220a and 220b each having first and second ends supporting the output shaft 108, in which a portion of the elastic member 220a and 220b between the first and second ends is fixed to the fixed housing 200. These features are the same as those described above and therefore a detailed description thereof will be omitted below.

Referring to FIGS. 6 and 7, the top end of the output shaft 108 is provided with protruding ends 221 axially protruding and supported on the first and second ends of the elastic members 220a and 220b, in which each of the protruding ends 221 is configured such that the opposite sides of the protruding ends 221 of the output shaft 108 in the radial direction about the central axis are parallel to each other.

In addition, the top end of the output shaft 108 is provided with a coupling protrusion 225 axially protruding from the protruding ends 221 to be coupled to the first rotational support member 250.

Referring to FIGS. 8 to 10 together, the first rotational support member 250 includes an annular inner coupling member 253 coupled to the coupling protrusion 225 to rotate together with the output shaft 108, an annular outer coupling member 251 axially supported by the fixed housing 200 of the torsion restoring member 210 and radially supported by and fixed to the inner circumferential surface of the insertion portion 106a, and a first rolling member 255 coupled between the inner coupling member 253 and the outer coupling member 251 to support rotation of the inner coupling member 253.

In an embodiment, the first rolling member 255 may be implemented as a ball, and the inner circumferential surface of the insertion portion 106a is provided with a coupling surface 202 to which the first rolling member 255 is coupled.

The present embodiments may further include a second rotational support member 260 coupled between the inner surface 204 of the insertion portion 106a and the first rotational support member 250 to support the rotation of the inner coupling member 253.

The second rotational support member 260 may include a support member 261 supporting the inner surface 204 of the insertion portion 106a and the inner coupling member 253 and second rolling members 263 rotatably coupled to the support member 261 to support rotation of the inner coupling member 253.

In an embodiment, the second rolling members 263 may be implemented as rolls, and the inner surface 204 on which the second rolling members 263 are supported may be provided as a stepped portion having a decreasing inner diameter.

In an embodiment, an assembly process may be performed by the sequence of attaching the second rolling members 263 to the inner surface 204 of the insertion portion 106a, sliding the first cloud member 255 on the inner circumferential surface of the insertion portion 106a to be attached to the mating surface 202, and then attaching the torsion restoring member 210 and the output shaft 108 to the input shaft 106.

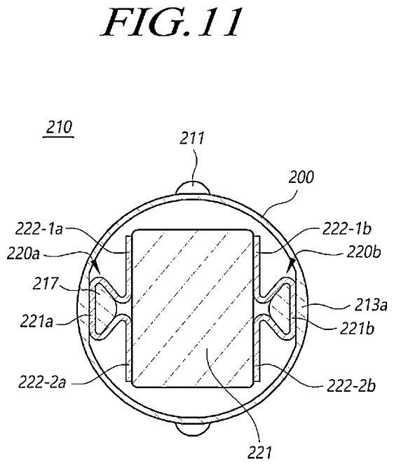

Referring to FIGS. 11 to 13, the operation of the torsion restoring member will be described as follows.

First, FIG. 11 shows the steering wheel in a neutral state, i.e., a state in which the driver is not operating the steering wheel and the vehicle is traveling straight, with the opposite sides of the protruding ends 221 uniformly supported on the elastic members 220a and 220b.

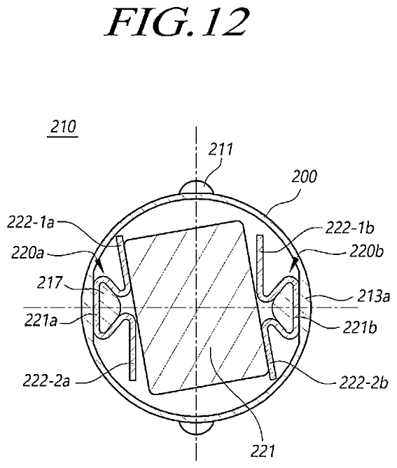

FIG. 12 shows a state in which the steering wheel is operated to rotate the protruding ends 221 counterclockwise, at which time a first end 222-1a of the left elastic member 220a and a second end 222-2b of the right elastic member 220b are compressed, thereby applying an elastic restoring force to the protruding ends 221.

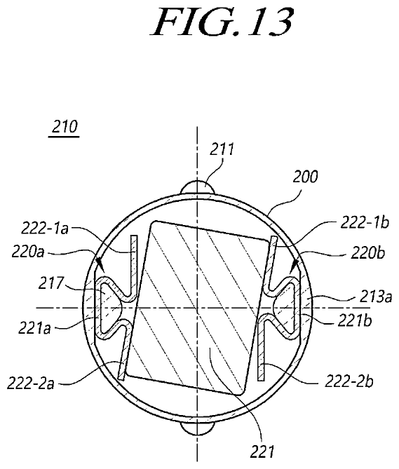

In contrast to FIG. 12, FIG. 13 shows a state in which the protruding ends 221 are rotated clockwise. Here, the second end 222-2a of the left elastic member 220a and the first end 222-1b of the right elastic member 220b are compressed, thereby applying an elastic restoring force to the protruding ends 221.

In addition, referring to FIGS. 2 to 13 together with FIG. 1, a vehicle according to the present embodiments includes a steering shaft 102 connected to a steering wheel 101, an input shaft 106 coupled to the steering shaft 102 and including an insertion portion 106a on an end of the input shaft 106, the insertion portion 106a having an inner space formed in the insertion portion 106a in an axial direction of the input shaft 106, an output shaft 108, wherein one end of the output shaft 108 is coupled to the insertion portion 106a and another end of the output shaft is coupled to a rack bar 120, a rack driver 113, 123, 150, 130, and 125 coupled to the rack bar 120 and configured to control movement of the rack bar 120, a torsion restoring member 210 coupled between the inner surface of the insertion portion 106a and the one end of the output shaft 108, coupled to the insertion portion 106a, and configured to be elastically deformable in response to rotation of the input shaft 106, a torque sensor 103 configured to sense torque of the input shaft 106, and an electronic controller 111 configured to output a control signals to the rack driver according torque of the input shaft 106.

The steering shaft 102, the input shaft 106, the output shaft 108, and the torsion restoring member 210 are the same as described above and will not be described in detail below.

As shown in FIG. 1, the rack driver 113, 123, 150, 130, and 125 coupled to the rack bar 120 to slide the rack bar 120 may include a motor 113 configured to driven in response to a control signal of the electronic controller 111, a motor pulley 123 coupled to the motor 113, a nut pulley 130 coupled to a ball nut 125 coupled to the rack bar 120, and a belt 150 connecting the motor pulley 123 and the nut pulley 130.

The torque sensor 103 is coupled to a first side of the input shaft 106 and is configured to sense the driver operating the steering wheel 101 and send an electrical signal to the electronic controller 111 to operate the motor 113.

The electronic controller 111 controls the motor 113 based on an electrical signal transmitted by the torque sensor 103 and electrical signals transmitted by the steering angle sensor 121, the speed sensor 122, and the like mounted on the vehicle.

The motor 113 may be coupled to a speed reducer to reduce the number of revolutions of the motor, and may slide the rack bar 120 from side to side by a belt 150 and a nut pulley 130 to steer both wheels 115 by tie rods 119 and knuckle arms 117.

In the drawings of the present embodiments, for the sake of brevity, the torque sensor 103 provided on the input shaft 106, the speed sensor 122 transmitting steering information to the electronic controller 190, and the steering angle sensor 121 are illustrated by way of example, but other devices, such as an ultrasonic sensor, an image sensor, a motor position sensor, and various radars and LiDARs, may be provided, and detailed descriptions thereof will be omitted.

According to embodiments of the present invention having the shapes and structures described above, both minimizing the cost increase and improving the assemblability may be achieved by replacing and commonizing existing torsion bars.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A vehicle steering apparatus comprising:
an input shaft coupled to a steering shaft and including an insertion portion on an end of the input shaft, the insertion portion of the input shaft having an inner space formed in the insertion portion in an axial direction of the input shaft;
an output shaft, wherein one end of the output shaft is coupled to the insertion portion of the input shaft and another end of the output shaft is coupled to a rack bar; and
a torsion restoring member coupled between an inner surface of the insertion portion of the input shaft and the one end of the output shaft, coupled to the insertion portion of the input shaft, and configured to be elastically deformable in response to rotation of the input shaft.

2. The vehicle steering apparatus of claim 1, wherein the torsion restoring member comprises:
a fixed housing fixed to the insertion portion of the input shaft; and
at least one elastic member having a first end and a second end supporting the output shaft, wherein a portion of the elastic member between the first and second ends of the elastic member is fixed to the fixed housing of the torsion restoring member.

3. The vehicle steering apparatus of claim 2, wherein the output shaft comprises:
an axially protruding support end protruding from the one end of the output shaft coupled to the insertion portion of the input shaft, and
stopper surfaces at sides of the axially protruding support end of the output shaft.

4. The vehicle steering apparatus of claim 3, wherein the insertion portion of the input shaft comprises a support surface on an inner circumferential surface of the end of the input shaft, the stopper surfaces of the output shaft supported by the support surface of the insertion portion of the input shaft.

5. The vehicle steering apparatus of claim 3, wherein the output shaft comprises a protruding end axially protruding from the axially protruding support end of the output shaft, and supported by the first and second ends of the at least one elastic member of the torsion restoring member.

6. The vehicle steering apparatus of claim 5, wherein opposite sides of the protruding end of the output shaft in a radial direction are parallel to each other.

7. The vehicle steering apparatus of claim 6, wherein the at least one elastic member comprises a pair of elastic members symmetrically disposed on the opposite sides of the protruding end of the output shaft.

8. The vehicle steering apparatus of claim 2, wherein the fixed housing of the torsion restoring member comprises:
a cylindrical portion coupled to the inner surface of the insertion portion of the input shaft;
a vertical partition extending from a first end of the cylindrical portion; and
fixing protrusions each protruding axially from the vertical partition such that the portion of the elastic member between the first end and the second end of the elastic member is coupled to one of the fixing protrusions.

9. The vehicle steering apparatus of claim 8, wherein the cylindrical portion of the fixed housing of the torsion restoring member radially comprises protruding support protrusions protruding from an outer circumferential surface of the cylindrical portion, and the insertion portion of the input shaft comprises seating recesses on the inner surface of the insertion portion, wherein the radially protruding support protrusions are inserted into the seating recesses of the insertion portion of the input shaft.

10. The vehicle steering apparatus of claim 8, wherein the fixing protrusions of the fixed housing of the torsion restoring member are spaced apart from an inner circumferential surface of the cylindrical portion, and the portion of the elastic member between the first and second ends of the elastic member is disposed between the inner circumferential surface of the cylindrical portion and one of the fixing protrusions of the fixed housing of the torsion restoring member.

11. The vehicle steering apparatus of claim 10, wherein one of the fixing protrusions of the fixed housing of the torsion restoring member comprises a flat surface facing the inner circumferential surface of the cylindrical portion, the cylindrical portion comprises a flat surface on the inner circumferential surface of the cylindrical portion, the flat surface of the one of the fixing protrusions of the fixed housing of the torsion restoring member is parallel to the flat surface of the cylindrical portion.

12. The vehicle steering apparatus of claim 11, wherein one of the fixing protrusions of the fixed housing of the torsion restoring member comprises inclined portions extending radially from ends of the flat surface facing the inner circumferential surface of the cylindrical portion.

13. A vehicle steering apparatus comprising:
an input shaft coupled to a steering shaft and comprising an insertion portion on an end of the input shaft, the insertion portion of the input shaft having an inner space formed in the insertion portion in an axial direction of the input shaft;
an output shaft, wherein one end of the output shaft is coupled to the insertion portion of the input shaft and another end of the output shaft is coupled to a rack bar;
a torsion restoring member coupled between an insertion portion and the one end of the output shaft, coupled to the insertion portion of the input shaft, and configured to be elastically deformable in response to rotation of the input shaft; and
a rotational support member coupled to the one end of the output shaft and coupled between an inner surface of the insertion portion of the input shaft and the torsion restoring member to support rotation of the output shaft.

14. The vehicle steering apparatus of claim 13, wherein the torsion restoring member comprises:
a fixed housing fixed to the insertion portion of the input shaft; and
an elastic member having a first end and a second end supporting the output shaft, wherein a portion of the elastic member between the first and second ends is fixed to the fixed housing of the torsion restoring member.

15. The vehicle steering apparatus of claim 14, wherein the output shaft comprises a protruding end axially protruding from the one end of the output shaft and supported by the first and second ends of the elastic member of the torsion restoring member, wherein opposite sides of the protruding end of the output shaft in a radial direction are parallel to each other.

16. The vehicle steering apparatus of claim 15, wherein the output shaft comprises a coupling protrusion on the one end of the output shaft and axially protruding from the protruding end of the output shaft to be coupled to the rotational support member.

17. The vehicle steering apparatus of claim 16, wherein the rotational support member comprises:
an inner coupling member coupled to the coupling protrusion of the output shaft to rotate together with the output shaft;
an annular outer coupling member axially supported by the fixed housing of the torsion restoring member and radially supported by and fixed to an inner circumferential surface of the insertion portion of the input shaft;
an outer coupling member axially supported by the fixed housing and radially supported by and fixed to the inner circumferential surface of the insertion portion of the input shaft; and
a first rolling member coupled between the inner coupling member and the outer coupling member to support rotation of the inner coupling member.

18. The vehicle steering apparatus of claim of 17, further comprising another rotational support member coupled between the inner surface of the insertion portion of the input shaft and the rotational support member to support the rotation of the inner coupling member.

19. A vehicle comprising:
a steering shaft connected to a steering wheel;
an input shaft coupled to the steering shaft and comprising an insertion portion on an end of the input shaft, the insertion portion of the input shaft having an inner space formed in the insertion portion in an axial direction of the input shaft;
an output shaft, wherein one end of the output shaft is coupled to the insertion portion of the input shaft and another end of the output shaft is coupled to a rack bar;
a rack driver coupled to the rack bar and configured to control movement of the rack bar;
a torsion restoring member coupled between an inner surface of the insertion portion of the output shaft coupled and the one end of the output shaft, coupled to the insertion portion of the input shaft, and configured to be elastically deformable in response to rotation of the input shaft;
a torque sensor configured to sense torque of the input shaft; and
an electronic controller configured to output a control signal to the rack driver according to the torque of the input shaft.

20. The vehicle of claim 19, wherein the rack driver comprises:
a motor configured to be driven in response to the control signal of the electronic controller;
a motor pulley coupled to the motor;
a nut pulley coupled to a ball nut coupled to the rack bar; and
a belt connecting the motor pulley and the nut pulley.
